(19) United States
(12) Patent Application Publication
(10) Pub. No.: US 2004/0249792 A1
(43) Pub. Date: Dec. 9, 2004

(54) Automated query file conversions upon switching database-access applications

(76) Inventor: Salman Halim, Pennsauken, NJ (US)

Correspondence Address: HEWLETT-PACKARD COMPANY, Intellectual Property Administration, P.O. Box 272400, Fort Collins, CO, 80527-2400, US

(21) Appl. No.: 10/453,970

(22) Filed: Jun. 4, 2003

(51) Int. Cl. G06F 7/00

(52) U.S. Cl. 707/3

(57) ABSTRACT

The invention utilizes automated processing to generate Java-based programming elements, such as Data Access Objects (DAOs), in order to facilitate a conversion from use of a first database-access application to a second database-access application. A different Java-based programming element may be generated for each query text file of the first application, where the Java-based programming elements are compatible with execution of the second application. For queries that include value placeholders that are provided to accommodate dynamic input of values during operation of the first application, the automated processing includes mapping the value place-holders and other query parameters to the Java-based programming elements.

### TECHNICAL FIELD

The invention relates generally to enabling access of information within databases and more particularly to techniques for transitioning from a first database-accessing platform to a second database-accessing platform.

### BACKGROUND ART

It is common to store information in database form, such as a relational database consisting of a number of related tables of data. The data in a table may be organized in columns and rows, with each column including a column name and/or another attribute that is common to the column, while the rows contain the records and data for the columns. In a simple example, a table of business contacts may include a name column, an address column, and a telephone number column. Each row is populated by the information specific to a particular business contact. In this example, the collection of information within a particular row relates to a single person, so that the information is referred to collectively as a “record” having three “fields.” A benefit of storing information in a database is that the segments of information may be easily manipulated.

In order to isolate a user from the complexity of the data storage, a Database Management System (DBMS) is provided as a software level mechanism for managing database information. The Structured Query Language (SQL) has been accepted as the standard for communications in a DBMS. Using SQL, a number of different types of queries can be formulated. The two basic types of queries are those that return data from a database and those that perform updates to the data in the database, so that the only return is an indication of status. Within the type of query that returns data, the calls typically start with the word “SELECT.” Such a query provides the criteria for selecting information from a table. A sample query of this type from the “Personnel” table is:

SELECT*FROM Personnel WHERE LastName=‘Smith’

Typically, the name within this query (i.e., “Smith”) is not hard-coded. Instead, the name is entered by a user during runtime. Thus, a value placeholder for the last name is used. Such a query is referred to as Dynamic SQL, or a DSQL object. The DSQL object for the sample query could be:

SELECT*FROM Personnel WHERE LastName=#lname, WRAP, Smith#

This DSQL object would be formed for a database-accessing application designed using Sapphire/Web, which is a federally registered trademark by Bluestone, Inc. for a computer program which creates Web-to-database applications. That is, Sapphire/Web is a tool specifically designed for linking Web front ends to a database. A Web front end may be HyperText Markup Language (HTML) and/or Java, which is a federally registered trademark by Sun Microsystems, Inc. for computer programs used in developing and executing other computer programs, particularly those implemented for the global communications network referred to as the Internet.

Regarding the second basic type of query, the syntax for a query beginning with the verbs “INSERT,” “UPDATE” and “DELETE” is similar to that of a “SELECT” query. In addition to the two basic types of database queries, other database calls are known.

While SQL has been established as the standard language for interactions with database servers and the like, the syntax of the SQL query will vary from one database-access application to another. In at least one database-access application (i.e., Sapphire/Web application), SQL queries are stored in individual text files with the value placeholders for the user input parameters. Often, the format of one application is not compatible with the requirements of another application. For example, Sapphire/Web stores queries as text files, but a J2EE application typically places the queries into the program code itself. Sapphire/Web creates the “front-end,” as well as providing the linkage between the front-end and the database. On the other hand, database access must be designed into a J2EE application and there are guidelines (Data Access Objects (DAOs)) for the queries, but no set mechanisms. Consequently, there are difficulties for an enterprise intending to convert from one database-access application to another, such as a conversion from a Sapphire/Web application to a J2EE application. A complete restructuring of the application is necessary. As another approach, the text files used in the original application may be manually recoded to provide compatibility with the second application. There may be similar situations in which compatibility issues require recodification. Clearly, this is a time intensive operation.

### SUMMARY OF THE INVENTION

The invention utilizes automated processing and Java-based programming elements to facilitate a conversion from use of a first database-access application to a second database-access application. The files which individually contain predetermined query statements for the first database-access application are parsed in order to determine the query parameters. At least some of the query statements will include value placeholders for accommodating dynamic input of values (e.g., last names) during operation of the first database-access application. In response to detecting the query parameters of the parsed files, Java-based programming elements are generated to correspond with the original query statements. The automated processing includes mapping the value placeholders and other query parameters from the parsed files to the Java-based programming elements.

The automated processing is well suited for a switch from a Sapphire/Web application to a J2EE application. Thus, the file parsing manipulates Structured Query Language (SQL) statement files in order to generate corresponding JavaBeans, such as Data Access Objects (DAOs) or servlets. A DAO may be generated for each SQL statement file, so that a statement file associated with the first database-access application has a correspondence with a specific DAO. It may be necessary to generate a base Java interface that is implemented for all DAOs. In one implementation, there is a base Java interface, while each SELECT-based DAO implements the interface, executing its specific query.

As one possibility, the query parameters of the statement files associated with the original database-access application are entered into the JavaBeans as function parameters. However, the process is less complex if the query parameters are entered into the JavaBeans as properties. For a conversion from a Sapphire/Web application to a J2EE application, the name of a particular value placeholder may be mapped to the name of a property in the corresponding DAO, the Java Database Connectivity (JDBC) type may be mapped to the object type of the property, a WRAP type may be mapped to a String, and a NO_WRAP type may be mapped to a double. As is known in the art, JDBC is a registered trademark of Sun Microsystems, Inc. for computer programs used in accessing databases.

The method reduces the complexity in changing formats used to implement multi-tiered database accessing. In a web-to-database application, one tier is the collection of clients which may use browsers to access HTML documents, a middle tier may be a computing device (such as a personal computer) on which the database-access application is executed, and a third tier may be one or more servers, such as an HTML server and a database server. In switching the database-access application, the system will include the stored original database-access application (which may be associated with SQL files containing the query statements), a recently loaded second database-access application with runtime parameters incompatible with the original application, and stored programming that is specific to converting the original query files to a format compatible with the second application. The reformatting programming generates the JavaBeans having the correspondence with the original files.

### BRIEF DESCRIPTION OF THE DRAWINGS

FIG. 1 is a schematic view of an environment in which the present invention may be applied.

FIG. 2 is a block diagram of relevant components of a computing system in accordance with the invention.

FIG. 3 is a process flow of steps for implementing the invention in accordance with the embodiment.

### DETAILED DESCRIPTION

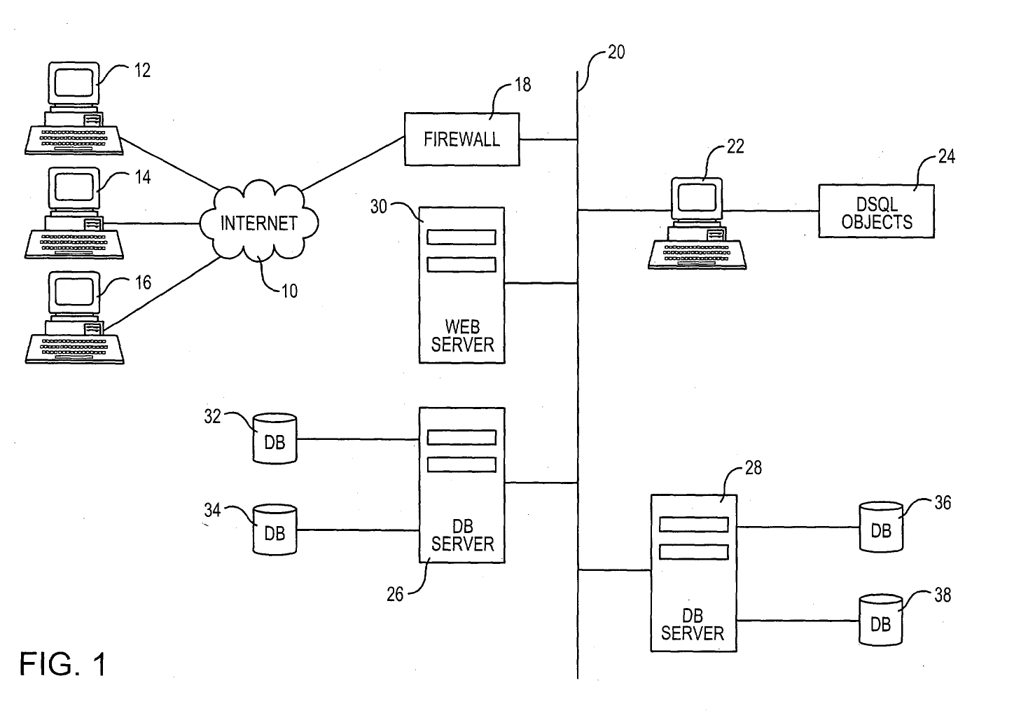

With reference to FIG. 1, one example of a multi-tiered database accessing system is illustrated, but the present invention may be used in other systems as well. For example, the database access may be limited to employees of a particular enterprise, rather than being extended to the public via the global communications network referred to as the Internet 10. In FIG. 1, various components have been omitted in order to reduce the complexity of the illustration.

Three computers 12, 14 and 16 are shown as being connected to the Internet 10. Each computer stores and executes a browser, as is well known in the art. The computers 12, 14 and 16 may link to an enterprise having a firewall 18 that provides security and privacy functions for the enterprise.

The firewall 18 is connected between the Internet 10 and an enterprise bus 20. Also connected to the bus 20 is a computer 22 for implementing a Database Management System (DBMS). The computer 22 may have an installed version of Sapphire/Web, which is a program for developers to create web-to-database applications, as well as HTML pages. That is, Sapphire/Web is designed to be a Java-and-web-to-database development tool for reducing the complexity of creating web applications. Similar development tools are known.

There are a number of different application objects that may be accessed in developing a web-to-database application, or other database accessing application in accordance with the invention. Among the application objections are dynamic SQL objects 24, which are shown separately in FIG. 1. DSQL objects may alternatively be stored at the hard drive of the computer 22 or may be separately connected to the bus 20. Some of the DSQL objects may include at least one value placeholder for a user input parameter. An example DSQL object is:

SELECT*FROM Personnel WHERE LastName=#lname, WRAP, Smith#

The placeholder consists of three parameters, of which the last one is optional. The first parameter is the name of the placeholder (lname). The second parameter is the type of the placeholder. This may be any type understood by the database. There are limited Java Database Connectivity (JDBC) types and there are two special Sapphire/Web types, namely WRAP and NO_WRAP. The WRAP causes the values to be treated as a string and quotation marks are automatically placed at opposite sides of the value, while the NO_WRAP type includes no quotation marks and is therefore useful for numerical expressions. The third parameter is an optional default value that is used to test the query during development. In the example DSQL object, the default value is “Smith.”

The system of FIG. 1 also includes two database servers 26 and 28 and includes a Web server 30, which is often referred to as an HTTP server. The first database server 26 may be Oracle compatible, while the second database server 28 may be Sybase compatible. Each database server is coupled to a pair of databases 32, 34, 36 and 38.

Any one of the personal computers 12, 14 and 16 may use a browser to communicate with the Web server 30, which may be used to store HTML forms, HTML templates, and other HTML documents. As an example of the sequencing, a request from one of the computers is transmitted via the Internet 10 and, if passed by the firewall 18, is processed at an application server that was created using Sapphire/Web. The application server 30 is cooperative with the database server 26 in responding to the request. Database information is sent to the computer as HTML pages.

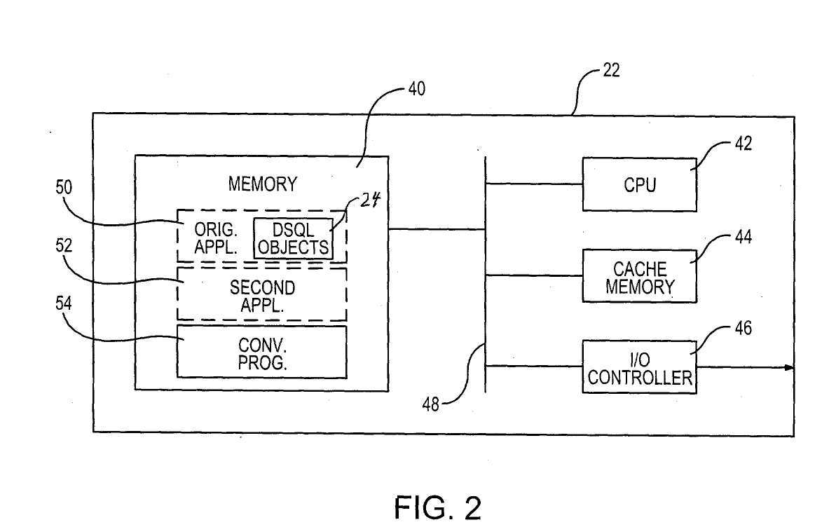

Referring now to FIGS. 1 and 2, relevant components of the computer 22 include non-volatile memory 40, such as a hard drive, a central processing unit (CPU) 42, cache memory 44, and an input/output controller 46. Communication among the various components of the computer may take place via a standard bus system 48. The CPU 42 provides the necessary processing for programs stored within the non-volatile memory 40. The cache memory 44 increases the efficiency of the processing by storing selected information from the non-volatile memory, so the CPU can access the information more readily. The input/output controller 46 enables communication with other devices.

Schematically shown within the non-volatile memory 40 are an original database-access application 50, a second database-access application 52 and conversion programming 54. The original and second applications are shown as dashed lines, since the conversion process does not require the second application and only needs the DSQL objects 24 (text files) from the first application. The original application 50 may be a Sapphire/Web application, while the second application 52 may be a recently designed J2EE application. As will be described in detail below, the conversion programming 54 is used in the automated process of generating Java-based programming elements which correspond to the query statements that were used by the original application 50. Thus, for a Sapphire/Web application, DSQL statement files may be converted to JavaBeans. For the placeholder which consists of all of the three above-identified parameters, the name of the placeholder (e.g., lname) may be mapped to the name of the JavaBean. The standard JDBC type may be mapped to the JavaBean type and the two Sapphire/Web proprietary types (i.e., WRAP and NO_WRAP) may be mapped to string and double, respectively. For the example of the query statement given above, the JavaBean may be named GetAllPersonnelDAO, with the JavaBean containing a String property called “lname” and with a default value of “Smith.” In operation, the user would have the option of setting “lname” to a value other than “Smith” before executing the query.

The conversion programming 54 may be initiated when a user of the computer 22 of FIGS. 1 and 2 changes from employing the original application 50 to employing the second application 52, but there may be other occasions in which automated conversion processing is used to preserve predefined query statements. That is, the conversion is a development procedure and is typically performed in the early stages of the second application's development, so that the second application will have some database access from which to operate.

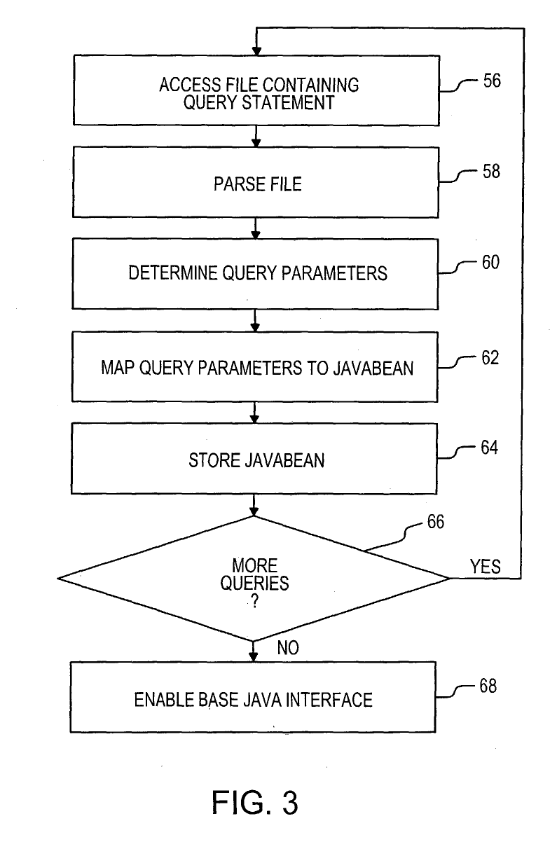

Referring to the process flow of FIG. 3, at step 56 of a conversion procedure, a first file containing a query statement is accessed. The accessed file may be one starting with the verb “SELECT,” “INSERT,” “UPDATE,” or “DELETE,” or may be another type of database call. In step 58, the file is parsed. Based upon the parsing, the query parameters of the file may be determined, as indicated at step 60. The determined query parameters are mapped to the JavaBean in step 62. As one concrete example of steps 56-62, the following SQL query is considered:

SELECT *
FROM Authors
WHERE LastName = #LastName, WRAP, Smith#
AND TotalSales >= #TotalSales, NO_WRAP, 20000#

The purpose of this query is to return information concerning authors who have a particular last name (wherein the default is “Smith”) and have had sales of at least the specified number (wherein the default value is 20000). Consequently, at runtime, the values for LastName and TotalSales would be provided by the user of one of the personal computers 12, 14 and 16 of FIG. 1. As one possibility, the user of the first computer 12 may access a web page using the computer's browser in order to enter the values “King” and “2000000”. It should be noted that the default values “Smith” and “20000” may not be included in all SQL query files of this types. However, once the query statement is populated with values, it appears as:

SELECT *
FROM Authors
WHERE LastName = ‘King’
AND TotalSales >= 2000000.

The original query statement would be stored as a DSQL object in a text file that has the same name as the DSQL object and the database with which it is expected to run:

ORACLE,AuthorDb,GetAllPublishedAuthors,O

This is the proprietary Sapphire/Web naming scheme for DSQL object files. The first parameter is the database server name, followed by the database name, the name of the DSQL object itself, and finally a code that provides an identification to Sapphire/Web of the type of the database (where O is the code for Oracle, S is the code for Sybase, etc.).

As noted at step 68, there may be embodiments in which a base Java interface is created. In converting the query statements of the original application 50 to DAOs, the base Java interface may be generated for implementation with all other DAOs in the same class. As one possibility, a base Java interface BaseDAO.java may be created as follows:

```
import java.sql.Connection;
import java.sql.ResultSet;
import java.sql.Statement;
/**
  * Parent class for all simple Data Access Objects.
  *
  */
public abstract class BaseDAO
{
  public BaseDAO ( )
  {
  }
  /**
    * Convenience method to execute a database query against a given
      connection.
    *
    * @param conn The database connection object
    * @param query The query to execute
    *
    * @return The return from the query
    *
    * @throws SQLException If something goes wrong
    */
  protected ResultSet executeQuery(Connection conn, String query)
    throws SQLException
  {
    Statement stmt = conn.createStatement( );
    return stmt.executeQuery( query );
  }
  /**
    * The method that will be overridden by child classes to execute the
    * query for the specific DSQL.
    *
    * @param conn The database connection object
    *
    * @return The return from the query
    *
    * @throws SQLException If something goes wrong
    */
  public abstract ResultSet executeQuery(Connection conn)
    throws SQLException;
}
```

Within this class, the SELECT-based DAO that is generated at the mapping step 62 implements functionality for executing the class. A significant difference between a Sapphire/Web application and a J2EE application is that while the DSQL object of the Sapphire/Web application is specific to a database, the corresponding DAO of the J2EE will not belong to a specific database. In the example of the Sapphire/Web naming scheme that was previously provided, the named DSQL object is specific to the Oracle database. On the other hand, following the conversion described in FIG. 3, it is the responsibility of the calling application to acquire a database connection and to pass the appropriate JavaBean or JavaBeans. This provides a greater flexibility and an ability to access any database that might match the schema, as compared to DSQL objects that are limited by the database to which they are assigned upon creation. At step 64 of FIG. 3, the JavaBean that is created at step 62 is stored in non-volatile memory. An example of a stored DAO (GetAllPublishedAuthorsDAO.java) is as follows:

```
import java.sql.Connection;
import java.sql.ResultSet;
import java.sql.SQLException;
/**
  * Gets all authors that have a given last name and have had at least the
  * specified number of sales.
  *
  */
public class GetAllPublishedAuthorsDAO
  extends BaseDAO
{
  protected String m_lastName = “Smith”;
  protected String m_totalSales = “20000”;
  public GetAllPublishedAuthorsDAO( )
  {
  }
  public void setLastName( String val )
  {
  m_lastName = val;
  }
  public String getLastName( )
  {
  return m_lastName;
  }
  public void setTotalSales( String val )
  {
  m_totalSales = val;
  }
  public String getTotalSales( )
  {
  return m_totalSales;
  }
  /**
  * The implementation method that executes the actual query.
  *
  * @see BaseDAO#executeQuery(java.sql.Connection)
  */
  public ResultSet executeQuery(Connection conn)
  throws SQLException
  {
  StringBuffer query = new StringBuffer( );
  query.append( “SELECT * FROM Authors WHERE LastName = ” );
  query.append( “” );
  query.append( m_lastName );
  query.append( “” );
  query.append( “AND TotalSales >=” );
  query.append( m_totalSales );
  return executeQuery( conn, query.toString( ) );
  }
}
```

Following the step 64 of storing the JavaBean, a determination is made at step 66 regarding whether at least one more query remains for conversion. If an affirmative response occurs, the process returns to step 56 of accessing the next appropriate SQL file. As a result of this looping, there will be a stored JavaBean for each SQL file containing a query statement for the original application 50.

Following the conversions of FIG. 3 and all other procedures for enabling the second application 52, the second application is ready for execution in performing database queries. Thus, the second application is run. As previously noted, it is the task of the calling routine to ensure that a database connection is established and to ensure that any necessary transactional scope is established prior to executing the query. During the step of executing the queries, parameters are supplied by the JavaBeans generated at step 62 and stored at step 64. The primary difference between queries that retrieve results (i.e., SELECT queries) and queries that perform updates (i.e., INSERT, UPDATE and DELETE queries), as related to implementation, is that an update style query returns only a status, which may be the shape of query metadata or an error code, whereas the result retrieval queries return complete Java ResultSet objects. However, in the running of the second application, this difference is not one which causes complications.

What is claimed is:

1. An automated method of preserving predefined query statements when converting from use of a first database-access application to a second database-access application, said automated method comprising:
parsing files which individually contain said predefined query statements;
determining query parameters of said files on a basis of said parsing, including identifying value placeholders for accommodating dynamic input of query values; and
generating a plurality of Java-based programming elements which correspond to said predefined query statements, including utilizing said query parameters in automatically generating said Java-based programming elements to be compatible with said second database-access application.

2. The method of claim 1 wherein said parsing manipulates Structured Query Language (SQL) statement files and wherein said generating includes forming JavaBeans.

3. The method of claim 1 wherein said generating is a step that includes generating a Data Access Object (DAO) for each said predefined query statement, each said DAO being configured to execute a query, said DAOs collectively enabling database updating and database information retrievals.

4. The method of claim 3 wherein said query parameters from said files are entered into said DAOs as properties.

5. The method of claim 4 wherein generating each said DAO includes mapping each said value placeholder to a property of said DAO.

6. The method of claim 5 wherein generating each said DAO includes:
mapping a name of said value placeholder to name of said DAO; and
mapping a type of said value placeholder to an object type of said DAO.

7. The method of claim 6 wherein said first database-access application is a Sapphire/Web application and said second database-access application is a J2EE application, said generating each said DAO including:
mapping a Java Database Connectivity (JDBC) type to said object type of said DAO; and
mapping a WRAP type to String or a NO_WRAP type to a double.

8. The method of claim 2 wherein said query parameters from said files are entered into said JavaBeans as function parameters.

9. The method of claim 2 wherein said generating includes forming servlets that correspond to said SQL statements.

10. A method of changing formats for implementing multi-tiered database accessing comprising:
identifying SQL objects that are specific to a first format;
providing programming that is specific to a second format for implementing multi-tiered database accessing; and
converting said SQL objects to JavaBeans that are compatible with implementing said multi-tiered database accessing on a basis of said second format, including utilizing programming for automating said converting.

11. The method of claim 10 wherein said identifying said SQL objects is a step of distinguishing SQL files generated using the Sapphire/Web platform for designing Web-to-database applications.

12. The method of claim 10 wherein said converting includes parsing said SQL objects using automated techniques, said SQL objects being text files that contain query statements for accessing a database, said converting further including generating at least one said JavaBean for each said SQL object, where at least some of said SQL objects include value placeholders which are mapped to said JavaBeans.

13. The method of claim 12 wherein said converting generates said JavaBeans as Data Access Objects (DAOs) configured to execute queries that correspond to queries defined by said SQL objects, including mapping said value placeholders to properties of said DAOs.

14. The method of claim 13 further comprising creating a base Java interface that is implemented by each of said DAOs to provide query functionality.

15. A computing system comprising:
stored SQL files which contain query statements, at least some of said query statements including value placeholders, said SQL files being compatible with a first database-access application; and
stored programming specific to converting said SQL files to a format compatible with a second database-access application, such that said stored programming enables automated conversion of said SQL files upon switching from said first database-access application to said second database-access application, said SQL files being incompatible with respect to running said second database-access application.

16. The computing system of claim 15 wherein said programming is configured to generate Data Access Objects (DAOs) which correspond to said SQL files, said DAOs being compatible with said second database-access application with respect to executing queries.

17. The computing system of claim 16 wherein said programming is enabled to map value placeholders of said SQL files to properties of said DAOs.

18. The computing system of claim 16 wherein said programming is enabled to map value placeholders of said SQL files to function parameters of said DAOs.

19. The computing system of claim 15 wherein said first database-access application is based upon a Sapphire/Web format and said second database-access application is based upon a J2EE format.
